(19) United States
(12) Patent Application Publication
(10) Pub. No.: US 2007/0249448 A1
(43) Pub. Date: Oct. 25, 2007

(54) Link plate for a chain

(75) Inventor: Daniel Wu, Tainan City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KMC CHAIN INDUSTRIAL CO., LTD.

(21) Appl. No.: 11/785,872

(22) Filed: Apr. 20, 2007

(30) Foreign Application Priority Data
Apr. 24, 2006 (TW) 095114535

(51) Int. Cl. F16G 13/02

(52) U.S. Cl. 474/206

(57) ABSTRACT

A link plate includes inner and outer side surfaces, and an inner surrounding surface defining a retaining hole engaging a retaining end portion of a link pin. The inner surrounding surface has a mounting portion disposed about a first central point, and a positioning portion disposed about a second central point and having two ends spaced apart from each other by a distance smaller than the diameter of the retaining end portion. A flange extends from the positioning portion, is adjacent to the inner side surface and distal from the outer side surface, and permits a shoulder of the link pin to abut thereagainst. Two bridging surface portions are disposed between the mounting portion and the positioning portion to define a passage allowing movement of the retaining end portion between the mounting portion and the positioning portion.

### CROSS-REFERENCE TO RELATED APPLICATION

This application claims priority of Taiwanese Application No. 095114535, filed on Apr. 24, 2006.

### BACKGROUND OF THE INVENTION

1. Field of the Invention

This invention relates to a link plate for a chain, and more particularly to a link plate that is connected to two link pins.

2. Description of the Related Art

Referring to FIG. 1, a chain typically includes a plurality of chain link units 5 and a connecting unit 6. Each of the chain link units 5 includes two inner chain plates 51. Each of the connecting units 6 includes two link plates 7, and a pair of first and second link pins 8, 8′ each having a retaining end portion 81 and a neck portion 82 adjacent to the retaining end portion 81. The link plates 7 are used to interconnect the link pins 8, 8′.

Referring to FIG. 2, in a first conventional assembly of the link plate 7 and the second link pin 8′, which is disclosed in Taiwanese Patent Publication No. 171756, the link plate 7 has a circular through hole 71 and a retaining hole 72 spaced apart from the through hole 71 and allowing the retaining end portion 81 of the second link pin 8′ to be anchored therewithin. The retaining hole 72 has a first hole portion 721 proximate to the through hole 71, and a second hole portion 722 distal from the corresponding through hole 71. The first and second hole portions 721, 722 intersect each other at two points 723 that are spaced apart from each other by a distance smaller than the diameter of the retaining end portion 81.

During assembly, the second link pin 8′ is inserted into the first hole portion 721 of the retaining hole 72 in the link plate 7 such that the retaining end portion 81 projects fully from the first hole portion 721. Next, the second link pin 8′ is moved away from the through hole 71 to align the retaining end portion 81 with a diameter-increased outer end of the second hole portion 722. Subsequently, the retaining end portion 81 is moved into the second hole portion 722. As such, since the retaining end portion 81 is received fittingly within the diameter-increased end of the second hole portion 722, movement of the retaining end portion 81 from the second hole portion 722 into the first hole portion 721 in a direction parallel to the link plate 7 can be prevented. That is, the second link pin 8′ can be retained effectively on the link plate 7.

In such a configuration, the second link pin 8′ is long, and a large space is formed between the link plate 7 and the inner chain plate 51. As a result, the width of the chain having the first conventional assembly is increased, thereby limiting the applicable range of the chain. For example, such a chain is not suitable for a multi-speed bicycle. Furthermore, due to the large space between the link plate 5 and the inner chain plate 51, in a situation where the first conventional assembly is applied to a bicycle, and when the bicycle advances on an uneven road surface, the link plate 7 and the inner chain plate 51 move relative to each other, and collide with each other, thereby resulting in a large amount of noise and even causing a damage thereto.

Referring to FIG. 3, in a second conventional assembly of the link plate 7 and the second link pin 8′, which is disclosed in Taiwanese Patent Publication No. 205326, a U-shaped flange 73 is formed in the retaining hole 72, and is spaced apart from an outer side surface 74 of the link plate 7. The retaining portion 81 of the second link pin 8′ abuts against the flange 73, is disposed between the flange 73 and the outer side surface 74, and has an end surface aligned with the outer side surface 74. However, the retaining end portion 81 may move toward the through hole 71 along the flange 73 and into a wider hole portion 75 of the retaining hole 72. This results in unintentional removal of the second link pin 8′ from the link plate 7. In other words, the second link pin 8′ cannot be retained effectively on the link plate 7.

### SUMMARY OF THE INVENTION

The object of this invention is to provide a link plate adapted for a chain and formed with a retaining hole that is defined by a inner surrounding surface, which has an improved structure so as to retain effectively a link pin thereon such that a space formed between the link plate and an inner chain plate is reduced.

According to this invention, a link plate includes inner and outer side surfaces, and an inner surrounding surface defining a retaining hole engaging a retaining end portion of a link pin. The inner surrounding surface has a mounting portion disposed about a first central point, and a positioning portion disposed about a second central point and having two ends spaced apart from each other by a distance smaller than the diameter of the retaining end portion. A flange extends from the positioning portion, is adjacent to the inner side surface and distal from the outer side surface, and permits a shoulder of the link pin to abut thereagainst. Two bridging surface portions are disposed between the mounting portion and the positioning portion to define a passage allowing movement of the retaining end portion between the mounting portion and the positioning portion.

Since the distance between the ends of the positioning portion of the retaining hole in the link plate is smaller than the diameter of the retaining end portion of the link pin, the link pin can be retained effectively on the link plate.

Furthermore, due to the presence of the bridging notches, the space formed between the link plate and an inner chain plate is reduced. Thus, when the link plate is applied to a bicycle chain, the noise generated during use of the bicycle chain is reduced, and the service life of the bicycle chain is increased.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a fragmentary sectional view of a conventional chain;

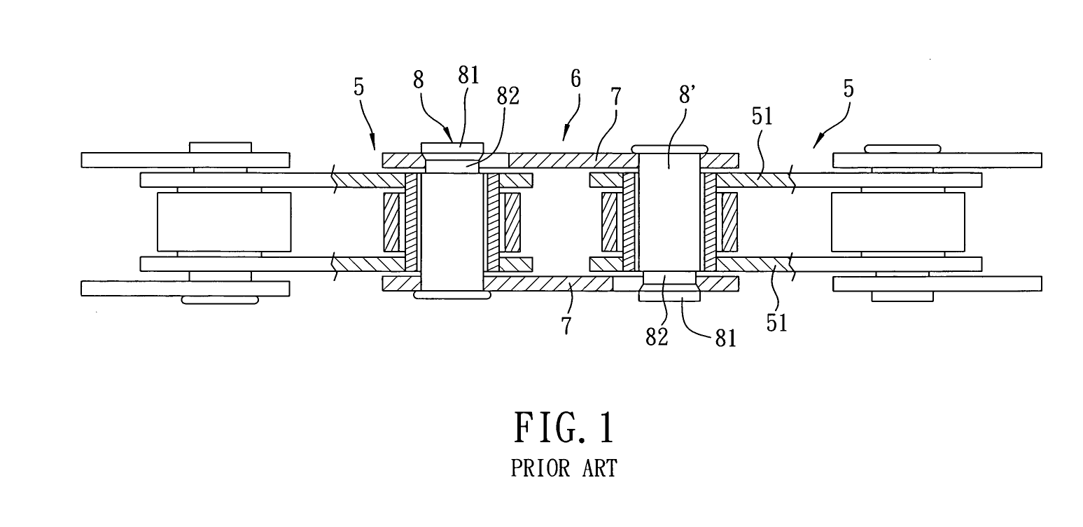

FIG. 2 is a schematic front view of a first conventional assembly of a link plate and a link pin, which is disclosed in Taiwanese Patent Publication No. 171756;

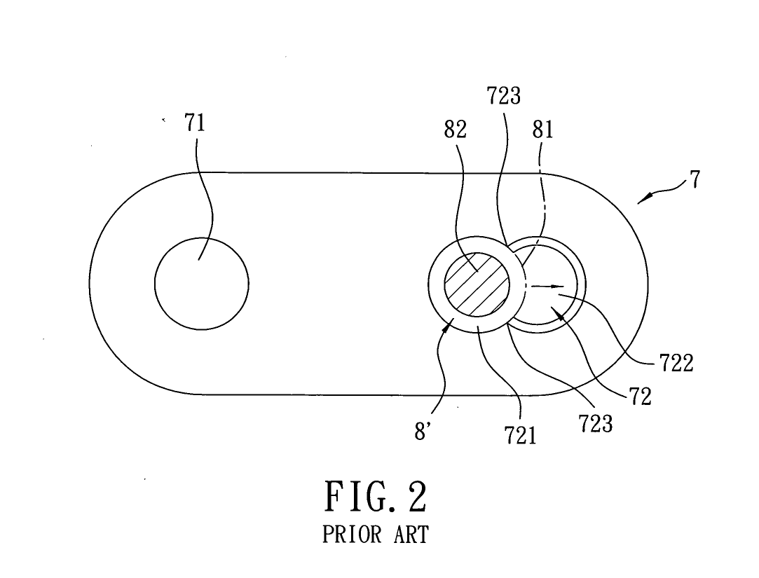

FIG. 3 is a schematic front view of a second conventional assembly of a link plate and a link pin, which is disclosed in Taiwanese Patent Publication No. 205326;

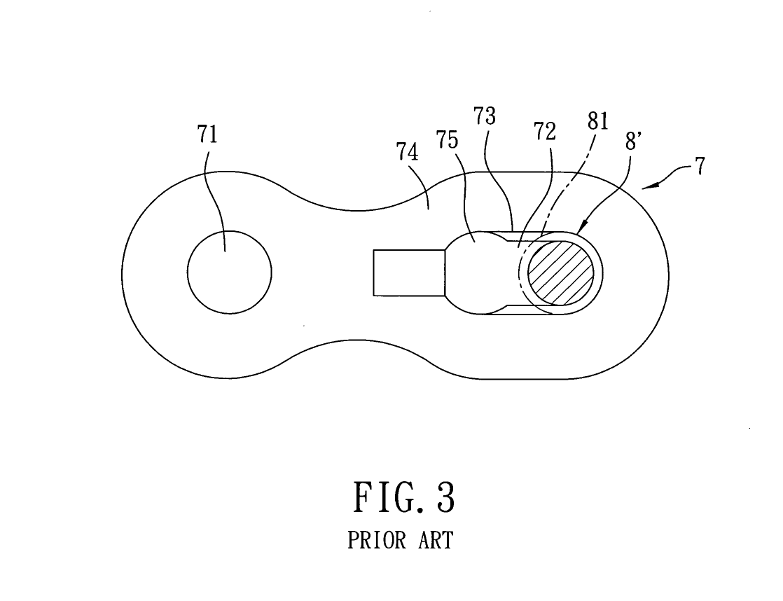

FIG. 4 is a fragmentary perspective view of a chain including the first preferred embodiment of a link plate according to this invention, illustrating connections among the link plate and other elements;

FIG. 5 is a fragmentary sectional view of two chain link units and a connecting unit of the chain shown in FIG. 4;

FIG. 6 is a perspective view of the first preferred embodiment;

FIG. 7 is a front view of the first preferred embodiment;

FIG. 8 is a fragmentary, partly exploded sectional view of the chain shown in FIG. 4, illustrating connections among the preferred embodiment and two link pins;

FIG. 9 is a fragmentary sectional view of the chain shown in FIG. 4, illustrating how a retaining end portion of one of the link pins is moved within a first hole portion of a retaining hole in the link plate to thereby project outwardly from a sliding surface portion;

FIG. 10 is a front view of the first preferred embodiment, illustrating how the link pin is located within a first hole portion of the retaining hole;

FIG. 11 is a front view of the first preferred embodiment, illustrating how the link pin is moved into a second hole portion of the retaining hole;

FIG. 12 is a perspective view of the second preferred embodiment of a link plate according to this invention;

FIG. 13 is a front view of the second preferred embodiment;

FIG. 14 is a perspective view of the third preferred embodiment of a link plate according to this invention; and

FIG. 15 is a front view of the third preferred embodiment.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

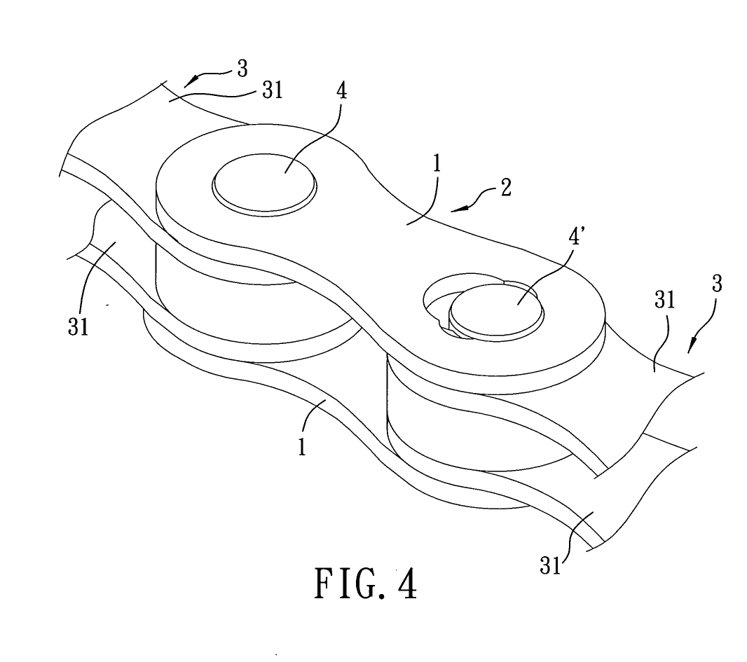

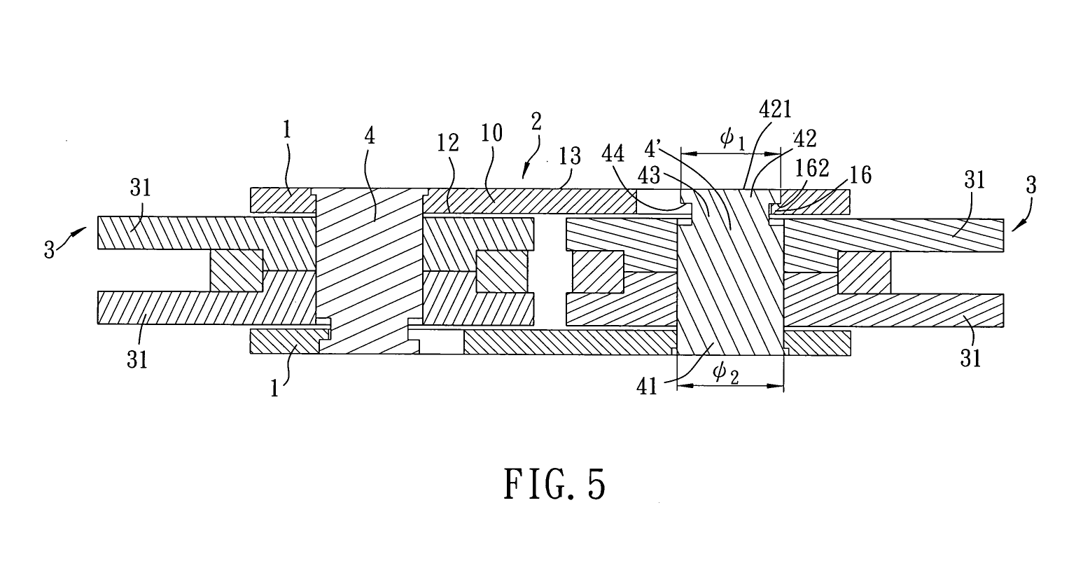

Referring to FIGS. 4 and 5, the first preferred embodiment of a link plate 1 according to this invention is one element of a chain. The chain includes a connecting unit 2 and a plurality of chain link units 3. The connecting unit 2 includes two link plates 1 and a pair of first and second link pins 4, 4′ for interconnecting an adjacent pair of the chain link units 3. Each of the chain link units 3 includes two parallel inner chain plates 31. Each of the first and second link pins 4, 4, has an anchoring end portion 41, a retaining end portion 42 opposite to the anchoring end portion 41 and having a diameter (ψ1) smaller than the diameter (ψ2) of the anchoring end portion 41, and a neck portion 43 connected to the retaining end portion 42 so as to define a shoulder 44 therebetween.

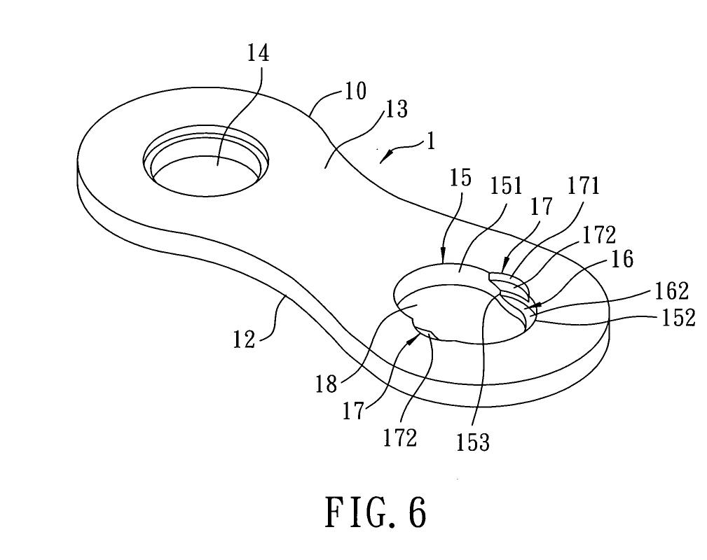

Referring to FIGS. 5, 6, 7, and 8, the link plate 1 includes an inner side surface 12 adjacent to the corresponding inner chain plate 31, an outer side surface 13 opposite to the inner side surface 12, a through hole 14 extending from the inner side surface 12 to the outer side surface 13 and allowing the anchoring end portion 41 of the first link pin 4 to be riveted therein, and an inner surrounding surface 15 extending from the inner side surface 12 to the outer side surface 13 to define a retaining hole 18. The retaining hole 18 is spaced apart from the through hole 14, and is used to allow for extension of the retaining end portion 42 of the second link pin 4′ therethrough.

The link plate 1 is gourd-shaped, and has two opposite annular end portions 131, and a contracted middle portion having two opposite sides 132.

The inner surrounding surface 15 has a mounting portion 151 disposed about a first central point (A), and a positioning portion 152 disposed about a second central point (B). The positioning portion 152 has two positioning ends 153 connected respectively to two ends of the mounting portion 151 and spaced apart from each other by a distance (d1) smaller than the diameter (ψ1) of the retaining end portion 42. As such, the retaining hole 18 has a first hole portion 181 defined by the mounting portion 151, and a second hole portion 182 defined by the positioning portion 152.

The link plate 1 further includes a flange 16 extending from the positioning portion 152 of the inner surrounding surface 15 toward the second central point (B), and two bridging notches 17 formed between the inner surrounding surface 15 and the outer side surface 13 and between the mounting portion 151 and the positioning portion 152 of the inner surrounding surface 15. The flange 16 is adjacent to the inner side surface 12 and distal from the outer side surface 13, and has an extension face 161 coplanar with the inner side surface 12, and an abutment face 162 parallel to the extension face 161. The shoulder 44 of the corresponding one of the first and second link pins 4, 4′ abuts against the abutment face 162.

The bridging notches 17 are located respectively to two sides of a longitudinal line (L1) extending through the first and second central points (A, B). Each of the bridging notches 17 is defined by a bridging surface portion 171 and a sliding surface portion 172. The bridging surface portions 171 extend from the outer side surface 13 toward the inner side surface 12, and face each other so as to define a passage permitting movement of the retaining end portion 42 of the corresponding one of the first and second link pin 4′ between the mounting portion 151 and the positioning portion 152 of the inner surrounding surface 15 therethrough. That is, a minimum distance between the bridging surface portions 171 is greater than the diameter (ψ1) of the retaining end portion 42. In this embodiment, each of the bridging surface portions 171 is curved, and has a first end 173 connected to the mounting portion 151, and a second end 174 connected to the positioning portion 152. The sliding surface portions 172 are parallel to the inner and outer side surfaces 12, 13, and are disposed on a plane located between the outer side surface 13 and the flange 16. The first ends 173 are spaced apart from a transverse line (L2) extending through the positioning ends 153 of the positioning portion 152 by a distance (d2) greater than the distance (d3) between the transverse line (L2) and a line (L3) extending through the first central point (A) and perpendicular to the longitudinal line (L1).

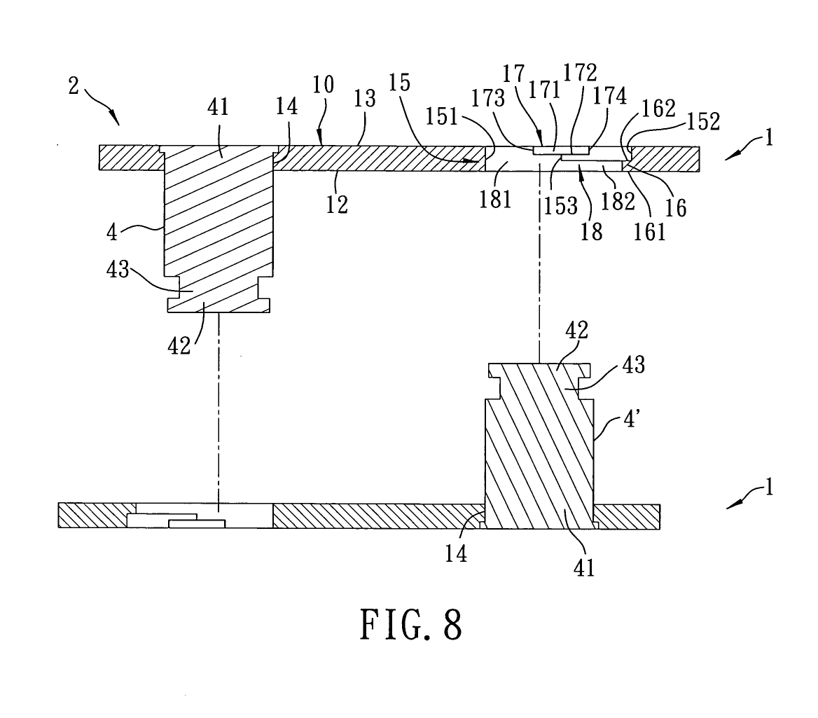

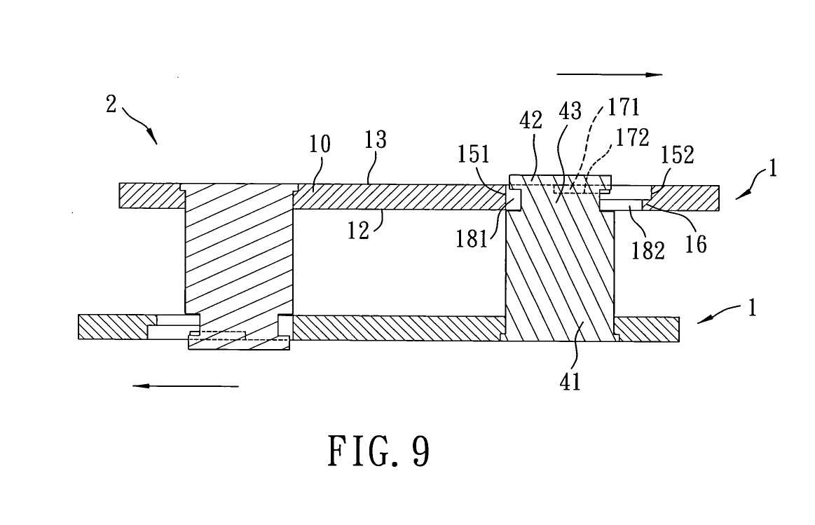

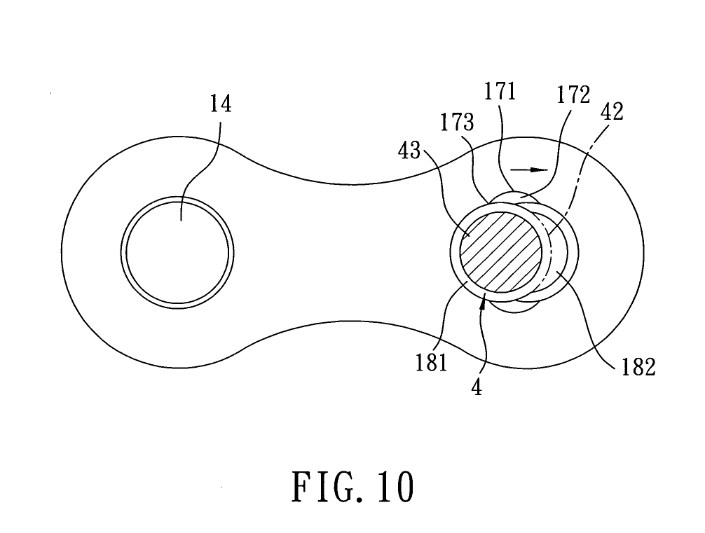

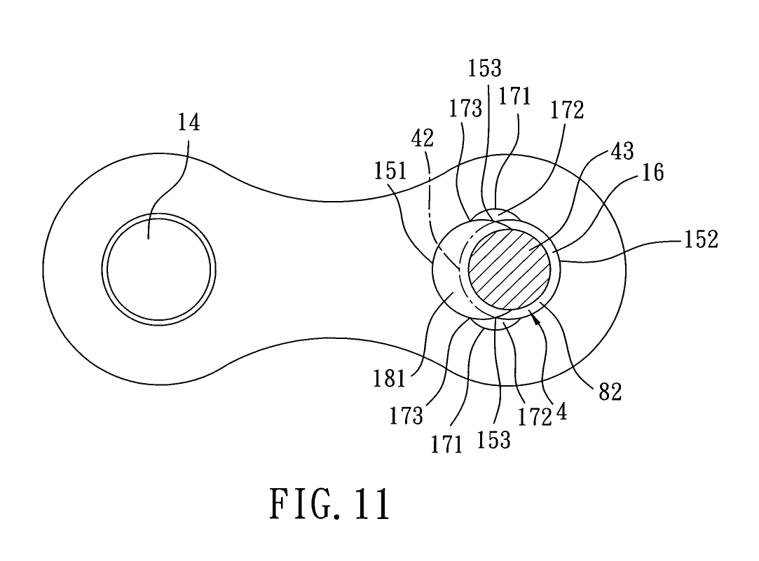

With particular reference to FIG. 8, during assembly of the connecting unit 2, the anchoring end portions 41 of the first and second link pins 4, 4′ are first riveted respectively within the through holes 14 in the link plates 1. The first and second link pins 4, 4′ are passed respectively through the chain link units 3 (see FIG. 5) and into the first hole portions 181 of the retaining holes 18 in the link plates 1 such that the retaining end portions 42 just project respectively and outwardly from the sliding surface portions 172, as shown in FIG. 9 (i.e., the flanges 16 are aligned respectively with the neck portions 43 of the first and second link pins 4, 4′). Subsequently, with additional reference to FIGS. 10 and 11, the retaining end portions 42 are moved respectively from the first hole portions 181 into the second hole portions 182 via the passage defined by the bridging surfaces 171, and then toward the flanges 16, respectively. As a consequence, an outer end surface 421 of each of the retaining portions 42 of the first and second link pins 4, 4′ is aligned with the outer side surface 13 of the corresponding link plate 1, as shown in FIG. 5. In this state, since the distance (d1) between the positioning ends 153 of each of the link plates 1 is smaller than the diameter (ψ1) of the corresponding retaining end portion 42, movement of the retaining end portions 42 from the second hole portions 182 into the first hole portions 181 in a direction parallel to the outer side surfaces 13 can be prevented. That is, the first and second link pins 4, 4′ can be retained respectively and effectively on the link plates 1.

Due to the presence of the bridging notches 17, the first and second link pins 4, 4′ can be shortened so as to reduce the space formed between each adjacent pair of the inner chain plate 31 and the link plate 1 and, thus, the noise generated during use of the chain, as compared to that occurring in Taiwanese Patent Publication NO. 171756.

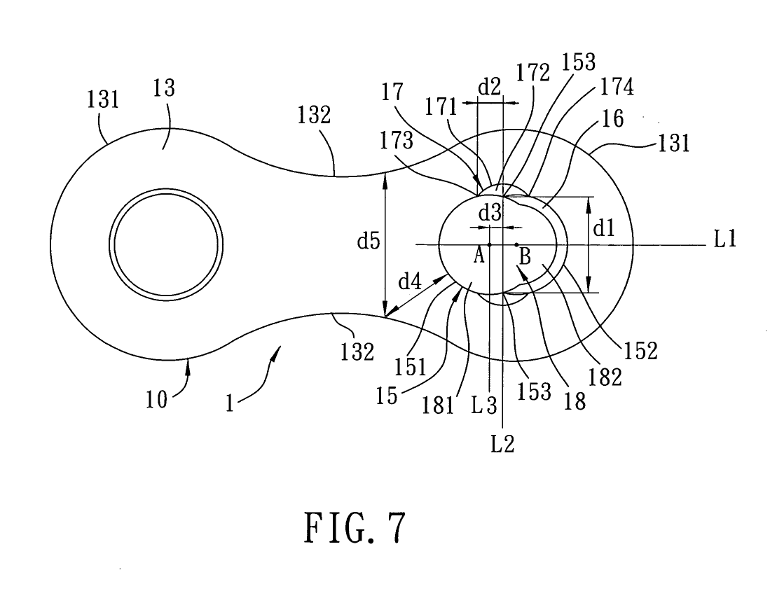

With particular reference to FIGS. 5 and 7, there may be cause for concern that such design of the inner surrounding surface 15 may result in a reduction in the distance (d4) between the mounting portion 151 and the sides 132 of the link plate 1, in which case, the link plate 1 could break at areas between the mounting portion 151 and the sides 132 of the link plate 1. To solve this possible breakage problem, the distance (d5) between the sides 132 may be increased. This, however, would affect adversely the engagement of the chain with a bicycle sprocket (not shown). In this embodiment, therefore, since the diameter (ψ1) of the retaining end portion 42 is smaller than the diameter (ψ2) of the anchoring end portion 41, the size of the inner surrounding surface 15 can be reduced so as to increase the distance (d4) between the mounting portion 151 and the sides 132 of the link plate 1.

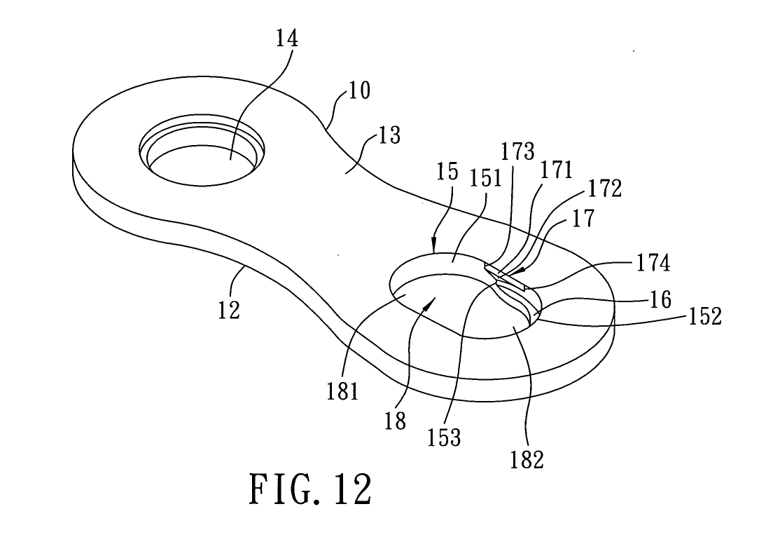

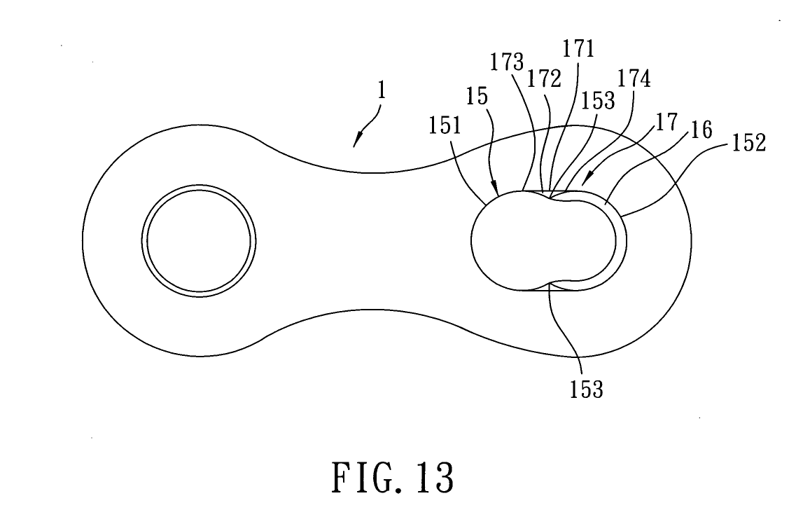

FIGS. 12 and 13 show modified bridging surface portions 171 that are flat, parallel to each other, and perpendicular to the inner and outer side surfaces 12, 13. The distance between the modified bridging surface portions 171 is greater than the diameter (ψ1) of the retaining end portion 42.

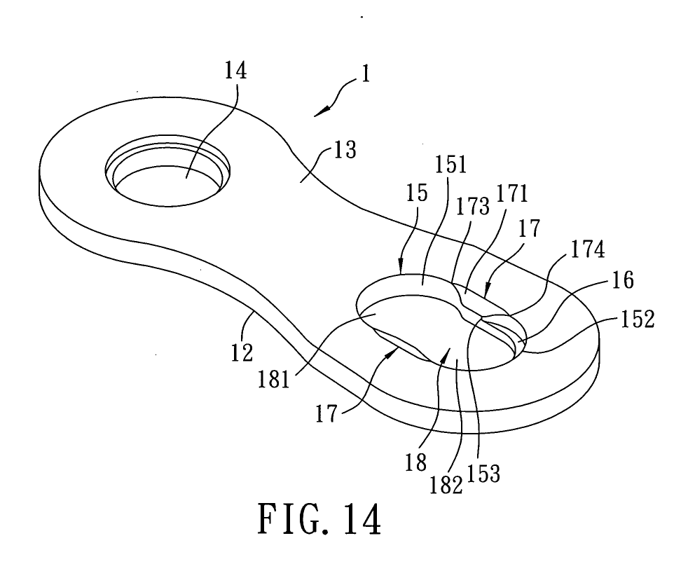

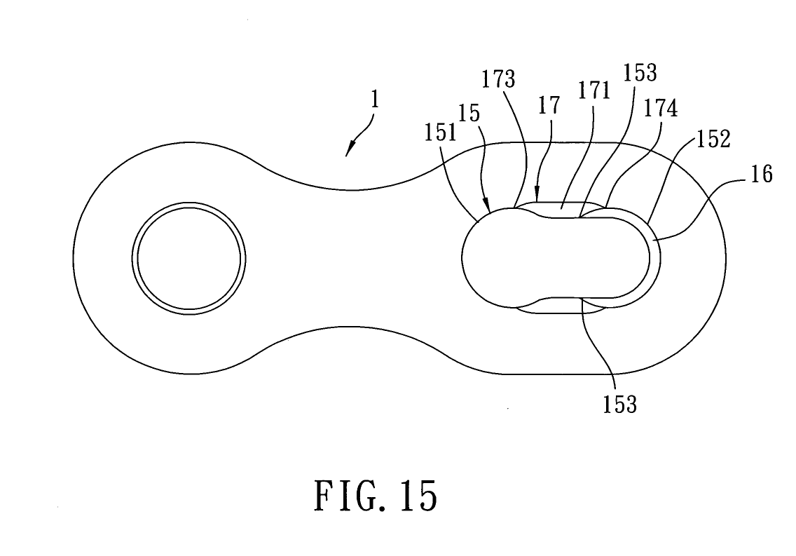

FIGS. 14 and 15 show modified bridging notches 17 that are defined merely by inclined bridging surface portions 171. In this embodiment, the sliding surface portions 172 are omitted.

With this invention thus explained, it is apparent that numerous modifications and variations can be made without departing from the scope and spirit of this invention. It is therefore intended that this invention be limited only as indicated by the appended claims.

I claim:

1. A link plate adapted to be connected to a pair of first and second link pins, each of the first and second link pins having an anchoring end portion, a retaining end portion opposite to the anchoring end portion, and a neck portion connected to the retaining end portion so as to define a shoulder therebetween, said link plate comprising:
an inner side surface;
an outer side surface opposite to said inner side surface;
a through hole extending from said inner side surface to said outer side surface and adapted to permit the anchoring end portion of the first link pin to be anchored therein;
an inner surrounding surface extending from said inner side surface to said outer side surface to define a retaining hole, said retaining hole being spaced apart from said through hole and adapted to allow for extension of the retaining end portion of the second link pin therethrough, said inner surrounding surface having a mounting portion disposed about a first central point and having two ends, and a positioning portion disposed about a second central point and having two opposite positioning ends connected respectively to said ends of said mounting portion, said positioning ends being spaced apart from each other by a distance smaller than a diameter of the retaining end portion of the second link pin;
a flange extending from said positioning portion of said inner surrounding surface toward said second central point, said flange being adjacent to said inner side surface and distal from said outer side surface, said flange being adapted to permit the shoulder of the second link pin to abut thereagainst; and
two bridging notches formed between said inner surrounding surface and said outer side surface and between said mounting portion and said positioning portion, said bridging notches being located respectively to two sides of a line extending through said first and second central points, said bridging notches being defined respectively by two bridging surface portions that extend from said outer side surface toward said inner side surface and that face each other so as to define therebetween a passage adapted to permit movement of the retaining end portion of the second link pin between said mounting portion and said positioning portion of said inner surrounding surface therethrough.

2. The link plate as claimed in claim 1, wherein said bridging surface portions are curved, a minimum distance between said bridging surface portions being greater than the diameter of the retaining end portion of the second link pin.

3. The link plate as claimed in claim 2, wherein said inner surrounding surface has two sliding surface portions that are parallel to said inner and outer side surfaces and that are disposed on a plane located between said outer side surface and said flange, each of said sliding surface portions cooperating with a corresponding one of said bridging surface portions so as to define a corresponding one of said bridging notches.

4. The link plate as claimed in claim 1, wherein said bridging surface portions are flat, parallel to each other, and perpendicular to said inner and outer side surfaces, a distance between said bridging surface portions being greater than the diameter of the retaining end portion of the second link pin.

5. The link plate as claimed in claim 4, wherein said inner surrounding surface has two sliding surface portions that are parallel to said inner and outer side surfaces and that are disposed on a plane located between said outer side surface and said flange, each of said sliding surface portions cooperating with a corresponding one of said bridging surface portions so as to define a corresponding one of said bridging notches.

6. The link plate as claimed in claim 1, wherein said bridging surface portions are inclined surfaces.

7. The link plate as claimed in claim 1, wherein said flange has an extension face coplanar with said inner side surface, and an abutment face parallel to said extension face and adapted to permit the shoulder of the second link pin to abut thereagainst.

8. The link plate as claimed in claim 1, wherein said outer side surface is adapted to align with an end surface of the retaining end portion.
